(19) United States
(12) Patent Application Publication
(10) Pub. No.: US 2023/0109692 A1
(43) Pub. Date: Apr. 13, 2023

(54) METHOD AND SYSTEM FOR PROVIDING ASSISTANCE TO INTERVIEWERS

(71) Applicant: Tata Consultancy Services Limited, Mumbai (IN)

(72) Inventors: ANUMITA DASGUPTA, Kolkata (IN); INDRAJIT BHATTACHARYA, Kolkata (IN); GIRISH KESHAV PALSHIKAR, Pune (IN); PRATIK SAINI, Gurgaon (IN); SANGAMESHWAR SURYAKANT PATIL, Pune (IN); SOHAM DATTA, Kolkata (IN); PRABIR MALLICK, Kolkata (IN); SAMIRAN PAL, Kolkata (IN); SUNIL KUMAR KOPPARAPU, Thane (IN); AISHWARYA CHHABRA, Thane (IN); AVINASH KUMAR SINGH, Kolkata (IN); KAUSTUV MUKHERJI, Thane (IN); MEGHNA ABHISHEK PANDHARIPANDE, Thane (IN); ANIKET PRAMANICK, Kolkata (IN); ARPITA KUNDU, Kolkata (IN); SUBHASISH GHOSH, Kolkata (IN); CHANDRASEKHAR ANANTARAM, Gurgaon (IN); ANAND SIVASUBRAMANIAM, Chennai (IN); GAUTAM SHROFF, Gurgaon (IN)

(73) Assignee: Tata Consultancy Services Limited, Mumbai (IN)

(21) Appl. No.: 17/822,722

(22) Filed: Aug. 26, 2022

(30) Foreign Application Priority Data
Oct. 12, 2021 (IN) 202121046587

(51) Int. Cl. G06Q 10/10; G06Q 10/06; H04L 12/18

(52) U.S. Cl. CPC G06Q 10/1053; G06Q 10/06311; H04L 12/1831

(57) ABSTRACT

This disclosure relates generally to method and system for providing assistance to interviewers. Technical interviewing is immensely important for enterprise but requires significant domain expertise and investment of time. The present disclosure aids assists interviewers with a framework via an interview assistant bot. The method initiates an interview session for a job description by selecting a set of qualified candidates resume to be interviewed. Further, the IA bot recommends each interviewer with a set of question and reference answer pairs prior initiating the interview. At each interview step, the IA bot records interview history and recommends interviewer with the revised set of questions. Further, an assessment score is determined for the candidate using the reference answer extracted from a resource corpus. Additionally, statistics about the interview process is generated, such as number and nature of questions asked, and its variation across to identify outliers for corrective actions.

### CROSS-REFERENCE TO RELATED APPLICATIONS AND PRIORITY

This U.S. Patent application claims priority under 35 U.S.C§ 119 to: Indian patent Application no. 202121046587, filed on Oct. 12, 2021. The entire contents of the aforementioned application are incorporated herein by reference.

### TECHNICAL FIELD

The disclosure herein generally relates to automated interview assistance, and, more particularly, to method and system for providing assistance to interviewers.

### BACKGROUND

In recent years number of technology companies are attempting to solve issues in the recruiting process which has grown tremendously. The proliferation of web-based technology for recruiting and matching has expanded employers’ and job seekers’ ability to find each other, but it has made the process of recruiting and matching increasingly complicated. The process of recruiting and matching is increasingly complicated as technology and business landscapes change at an ever-increasing pace, with a continual need to recruit fresh talent equipped in new technologies. Moreover, candidate interviews play a primary role in helping organizations to locate qualified job candidates. The most critical decision-making stage of the recruitment process is the interview of the candidate by domain experts. Here, the interviewers assess the technical and domain expertise, the thinking process, personality of the candidate, as well as his/her fitment with the role. This is done through a conversation, where the interviewers ask the candidate a sequence of long form questions about her core areas of expertise for technical assessment. This offers flexibility to the interviewer to ask follow-up or clarification questions when the candidate’s answers are deemed incomplete or ambiguous.

Conventionally, technical interviewing has been immensely important for organizations, which requires significant domain expertise and investment of time. A well-conducted interview provides an in-depth assessment of the candidate via brief interaction. Unfortunately, the benefits of the interview process come at a significant cost. Many large organizations have transitioned from hiring by visiting selected campuses to common qualifier tests followed by interviews, conducted remotely due to the pandemic. This has increased the volume of applications by an order of magnitude or more, stretching screening and interviewing resources. As a result, experts often conduct interviews haphazardly without much prior preparation, or by less-skilled interviewers. Both adversely affect the hiring quality and the candidate experience. In addition, few organizations maintain records of interview conversations, other than minimal notes or summary comments provided post-facto by interviewers. As a result, open questions remain about standards, robustness and fairness of the interviews. There have been attempts towards automating various parts of the recruitment and the interview process. Many organizations and start-ups have recently invested heavily in interview automation. Most of these focus on assessing the behavioral and personality traits of the candidates and their fitment with the organization rather than technical assessment. In addition, these focus on complete automation of the decision making, which has led to concerns about ethics and fairness.

### SUMMARY

Embodiments of the present disclosure present technological improvements as solutions to one or more of the above-mentioned technical problems recognized by the inventors in conventional systems. For example, in one embodiment, a system for providing assistance to interviewers is provided. The system initiates an interview session associated with interviewing a plurality of candidates for a job description conducted by one or more interviewers executed by an interview assistant bot by performing the steps of: identifying, a skill graph from an open domain knowledge graph by mapping curriculum with each skill required for the job description, wherein the skill graph annotates textual constructs associated with the interview session, wherein the curriculum comprises one or more concepts. Further, a candidate profile of each candidate and an interviewer profile of each interviewer is constructed, wherein the candidate profile is constructed by extracting concepts and its expertise level from resume, wherein the interviewer profile is constructed from prior interviewer actions, and using a resource corpus, a question bank comprising technical long form questions related to the curriculum is generated. Further, a set of qualified candidates resume to be interviewed for the job description are selected from a resume database, wherein each candidate resume includes atleast one concept associated with the skill graph. Then, for each interviewer the interview assistant bot recommends prior initiating the interview using a pre-interview question recommender, a set of question and reference answer pairs from the question bank relevant to each candidate profile. Further, the interview assistant bot recommends each interviewer at every interview step using an in-interview question recommender, a set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question. Finally, an assessment score for the candidate provided answer is determined using the reference answer extracted from the resource corpus and recommending next question to the candidate in response to the previous answer.

In another aspect, a method for providing assistance to interviewers is provided. The method includes to initiate an interview session associated with interviewing a plurality of candidates for a job description conducted by one or more interviewers executed by an interview assistant bot by performing the steps of: identifying, a skill graph from an open domain knowledge graph by mapping curriculum with each skill required for the job description, wherein the skill graph annotates textual constructs associated with the interview session, wherein the curriculum comprises one or more concepts. Further, a candidate profile of each candidate and an interviewer profile of each interviewer is constructed, wherein the candidate profile is constructed by extracting concepts and its expertise level from resume, wherein the interviewer profile is constructed from prior interviewer actions, and using a resource corpus, a question bank comprising technical long form questions related to the curriculum is generated. Further, a set of qualified candidates resume to be interviewed for the job description are selected from a resume database, wherein each candidate resume includes atleast one concept associated with the skill graph. Then, for each interviewer the interview assistant bot recommends prior initiating the interview using a pre-interview question recommender, a set of question and reference answer pairs from the question bank relevant to each candidate profile. Further, recommends each interviewer by the interview assistant bot at every interview step using an in-interview question recommender, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question. Finally, an assessment score for the candidate provided answer is determined using the reference answer extracted from the resource corpus and recommending next question to the candidate in response to the previous answer.

In yet another aspect, a non-transitory computer readable medium provides one or more non-transitory machine-readable information storage mediums comprising one or more instructions, which when executed by one or more hardware processors perform actions includes an I/O interface and a memory coupled to the processor is capable of executing programmed instructions stored in the processor in the memory to initiate an interview session associated with interviewing a plurality of candidates for a job description conducted by one or more interviewers executed by an interview assistant bot by performing the steps of: identifying, a skill graph from an open domain knowledge graph by mapping curriculum with each skill required for the job description, wherein the skill graph annotates textual constructs associated with the interview session, wherein the curriculum comprises one or more concepts. Further, a candidate profile of each candidate and an interviewer profile of each interviewer is constructed, wherein the candidate profile is constructed by extracting concepts and its expertise level from resume, wherein the interviewer profile is constructed from prior interviewer actions, and using a resource corpus, a question bank comprising technical long form questions related to the curriculum is generated. Further, a set of qualified candidates resume to be interviewed for the job description are selected from a resume database, wherein each candidate resume includes atleast one concept associated with the skill graph. Then, for each interviewer the interview assistant bot recommends prior initiating the interview using a pre-interview question recommender, a set of question and reference answer pairs from the question bank relevant to each candidate profile. Further, recommends each interviewer by the interview assistant bot at every interview step using an in-interview question recommender, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question. Finally, an assessment score for the candidate provided answer is determined using the reference answer extracted from the resource corpus and recommending next question to the candidate in response to the previous answer.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block of a system an example system alternatively referred as interview assistance system, according to some embodiments of the present disclosure.

FIG. 2A illustrates a high-level architecture providing automated assistant interface for interviewers using an interview assistant bot using the system of FIG. 1, according to some embodiments of the present disclosure.

FIG. 2B illustrates a skill graph with an example scenario mapping candidate’s skill required for the job description using the system of FIG. 1, according to some embodiments of the present disclosure.

FIG. 3 is a flow diagram illustrating the method with an example scenario associated with the interview session via the interview bot using the system of FIG. 1, according to some embodiments of the present disclosure.

FIG. 4 illustrates an example scenario associated with initiating an interview session between interviewers and candidate including interview assistant using the system of FIG. 1, according to some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

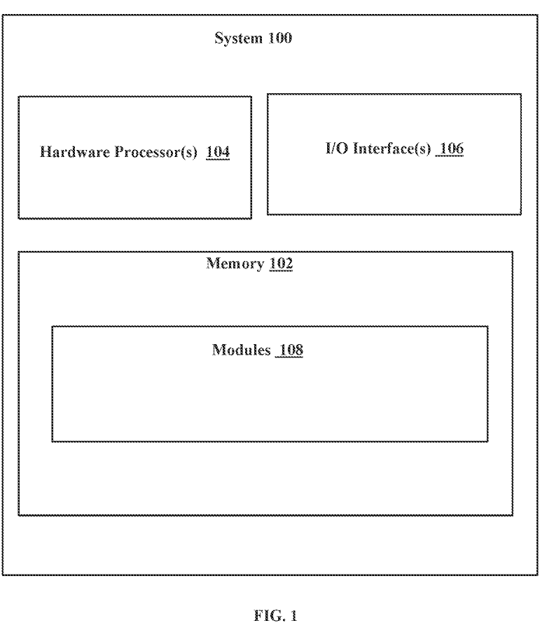

The embodiments herein provide a method and a system for providing assistance to interviewers. The disclosed method is an efficient interview assistance method addressing the challenge of reliability scaling on the hiring process ensuring interviewing standards. The system is a two-way communication process between each interviewer and the candidate with an interview assistant (IA) bot which monitors the two way communication, providing assistance to the interviewers at different stages of the interview. The IA bot provides assistance for (a) shortlisting candidates, (b) pre-interview question recommendations, (c) in-interview actions, such as in-interview question recommendation and skill-level assessments, and (d) post-interview summarization. In addition, the IA bot receives multiple forms of feedback from the interviewer and updates its recommendations. This collaboration between the interviewer and the IA bot has multiple advantages over automation which significantly reduces the load on the interviewers. Also, the present disclosure ensures interviewing standards as all decisions remain with experts. Initially, the system receives a request comprising a job description and a pool of candidates resume, where the entire interview process enables the interviewers to search for eligible candidates having specific skills. Before the interview is initiated, the IA bot recommends appropriate questions with reference answers to prime the interviewer. During the interview, the IA bot dynamically recommends next question to the interviewer to query the candidate and simultaneously answers are assessed to determine skill expertise of the corresponding candidate. The IA bot accommodates interviewer feedback and modifies its recommendations appropriately. Finally, post completion of interviews, the method shows ranking of each candidate for easy selection. More importantly, statistics are generated about the interview process such as number and nature of questions asked, and its variation across interviews. This statistic helps assessing the quality of interview process identifying outliers by taking corrective actions, as necessary. An example of the said system for providing assistance to interviewers is described with the disclosed method in conjunction with FIG. 1 to FIG. 4 below.

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary block of a system an example system alternatively referred as interview assistance system, according to some embodiments of the present disclosure. In an embodiment, the system 100 includes processor (s) 104, communication interface device(s), alternatively referred as or input/output (I/O) interface(s) 106, and one or more data storage devices or memory 102 operatively coupled to the processor (s) 104. The processor (s) 104 may be alternatively referred as one or more hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like. The I/O interface(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server or a centralized data lake used as source of input data by the system 100.

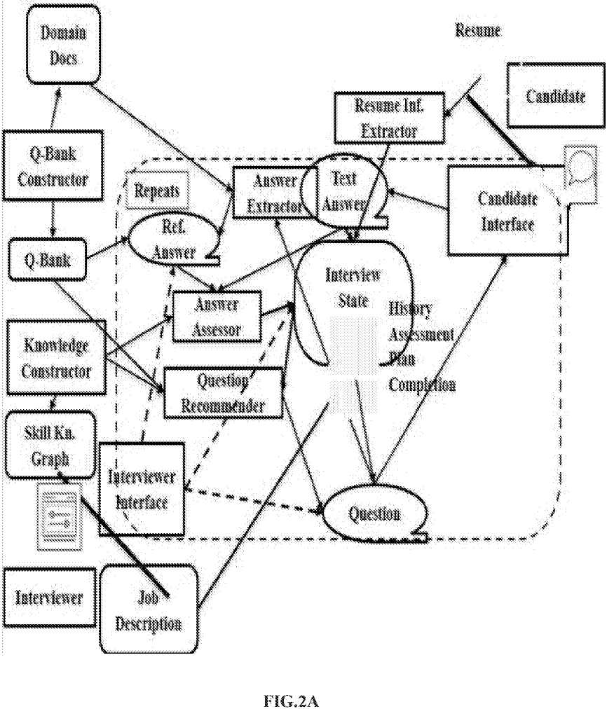

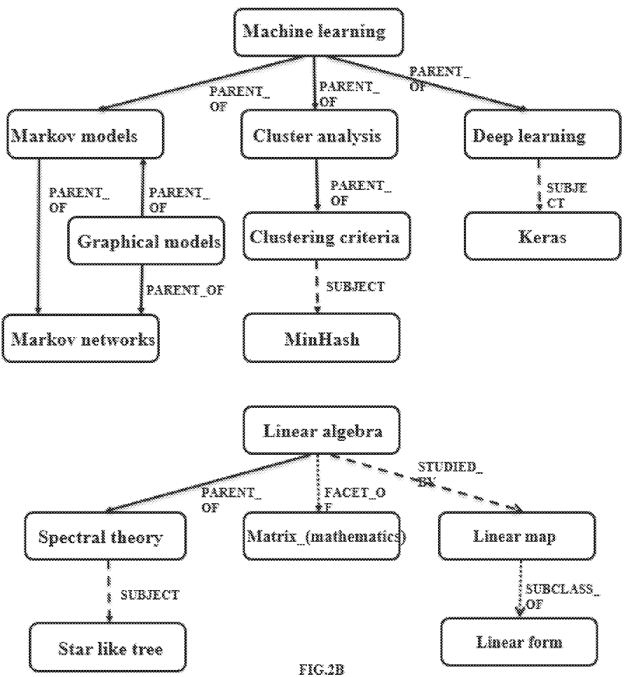

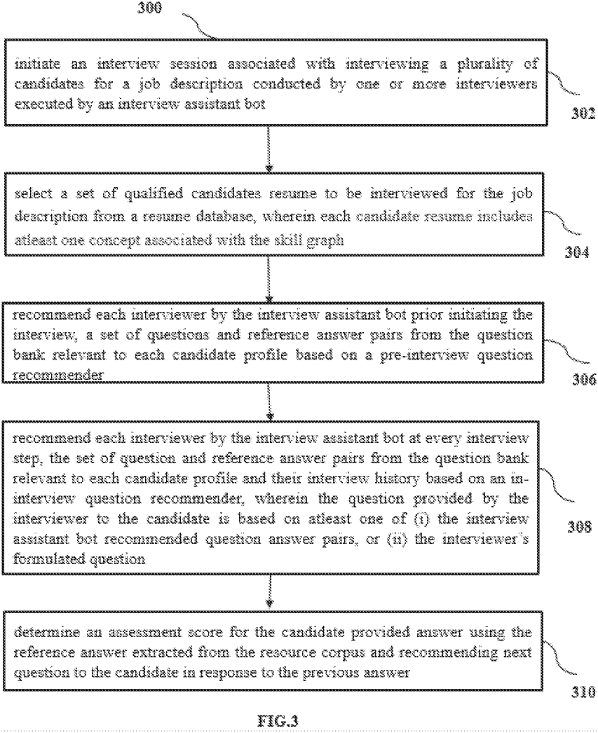

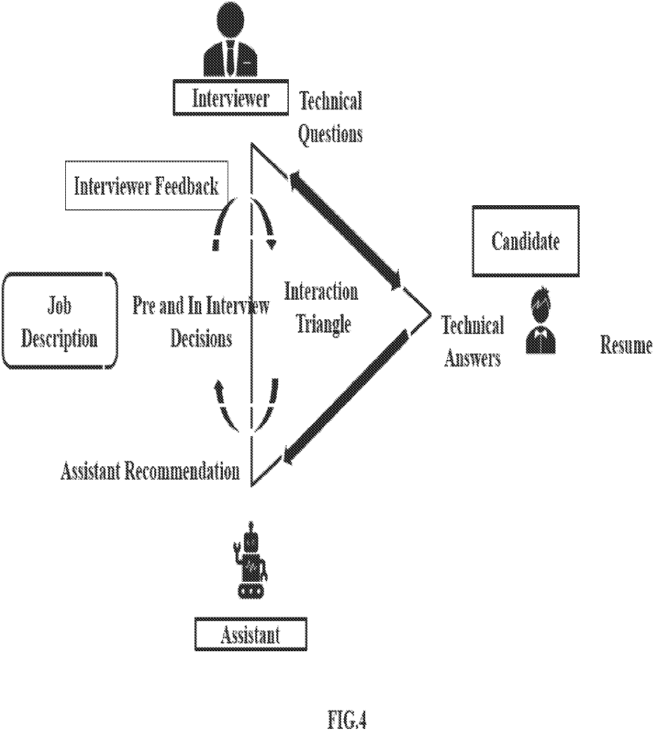

The memory 102 may include any computer-readable medium known in the art including, for example, volatile memory, such as static random-access memory (SRAM) and dynamic random access memory (DRAM), and/or non-volatile memory, such as read only memory (ROM), erasable programmable ROM, flash memories, hard disks, optical disks, and magnetic tapes. The memory 102 further may include modules 108. In an embodiment, the modules 108 includes a failure prediction module 110, for implementing functions of the system 100. In an embodiment, the modules 108 can be an Integrated Circuit (IC) (not shown), external to the memory 102, implemented using a Field-Programmable Gate Array (FPGA) or an Application-Specific Integrated Circuit (ASIC). The names (or expressions or terms) of the modules of functional block within the modules 108 referred herein, are used for explanation and are not construed to be limitation(s). The memory 102 may further comprise information pertaining to input(s)/output(s) of each step performed by the system 100 and methods of the present disclosure. The system processes a plurality of candidates resume for a job description conducted by one or more interviewers using the disclosed method that will be explained with reference to the accompanying diagrams in FIG. 3 and FIG. 4. The system 100 is further explained in detail in conjunction with FIG. 2A through FIG. 4.

FIG. 2A illustrates a high-level architecture providing automated assistant interface for interviewer’s interaction with candidates using an interview assistant bot using the system of FIG. 1, according to some embodiments of the present disclosure. FIG. 2A includes a plurality of components comprising a skill knowledge graph, a Question (q)-bank constructor, a resume information extractor, a question recommender, an answer assessor, and a candidate interface. Referring now to an example, where an enterprise performs a task to select a plurality of candidates appropriate for a job description. The domain of the interview is a collection of skills S, where skill s ∈ S corresponds to a broad technical area, such as Machine Learning, Deep Learning, Data Structures, Algorithms. Here, each skill s is represented using a set of concepts Vₛ and binary relations Eₛ between these concepts. Each edge Eₛᵢ is defined as a triple (uₛᵢ, tₛᵢ, vₛᵢ), where tₛᵢ denotes the type of the relation. For example, Supervised Learning, Unsupervised Learning, Classification, Model, Training data, Class label are concepts in Machine Learning. (Classification specializes Supervised Learning), (Model, part-of, Classification) are examples of relations. question bank constructor generates technical long form questions corresponding to various skills and extracts reference answers for these. The question and answers in the question bank are usually obtained from reference documents available in open source such as textbooks, Wikipedia® pages and curriculum associated with each skill. Mostly, these questions have answers spanning 2-5 sentences in length. An example scenario of the said system is described with the disclosed method in conjunction with FIG. 3 below.

FIG. 3 is a flow diagram illustrating the method with an example scenario associated with the interview session involving the interview bot using the system of FIG. 1, according to some embodiments of the present disclosure. The steps of the method 300 of the flow diagram will now be explained with reference to the components or blocks of the system 100 in conjunction with the example architecture of the system as depicted in FIG. 2A, FIG. 2B and FIG. 4. In an embodiment, the system 100 comprises one or more data storage devices or the memory 102 operatively coupled to the one or more processors 104 and is configured to store instructions for execution of steps of the method 300 by the one or more processors 104. In an embodiment, the memory 102 store instructions for execution of steps of the method 300 by the one or more processors 104, from software processes. Although process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

At step 302 of the method 300, pre-processing via the one or more hardware processors 104, to initiate an interview session associated with interviewing a plurality of candidates for a job description conducted by one or more interviewers executed by an interview assistant bot. Referring to the above example and FIG. 2B, the job description requires candidates with ‘high’ level (e.g., 5/5) of expertise in Machine Learning, along with ‘exposure’ level (e.g. ⅕) in Deep Learning. The recruitment starts with a set J of job descriptions. Each job description j specifies skills Sⱼ ⊂ S and concepts Vⱼ ⊂ ∪ₛ Vₛ with desired levels of expertise [symbol] and [symbol] associated with these. It is to be noted that the job description may additionally specify requirements at the level of concepts within skills, for example Unsupervised Learning within Machine Learning. The expertise levels come from an ordinal set {1, ..., L}. Consider the set R as candidate resumes r ∈ R has a set of skills Sᵣ and concepts Vᵣ with prior expertise assessments. Consider an example scenario with candidate’s resume that mentions an undergraduate course in Machine Learning, an online course in Deep Learning, and a project using HMM and Viterbi algorithm. Let Y^{r}(v) denote the prior expertise assessment for a concept v, and Y^{r}(s) for the skill s. For the said example resume, these may be ⅗ for Machine Learning, ⅘ for HMM and ⅕ for Deep Learning.

Referring now to FIG. 2B before initiating the interview session a skill graph is identified from an open domain knowledge graph by mapping curriculum with each skill required for the job description, wherein the skill graph annotates textual constructs associated with the interview session, wherein the curriculum comprises one or more public knowledge graphs such as DBPedia and Wikipedia® data contains a lot of knowledge about many skills. But being open domain, only a small subset is relevant for a skill. So, given such a larger knowledge graph as specified below in equation 1,

$$G = \left(V , E\right) ,$$

addressing the problem of identifying the skill-graph for a skill s as a sub-graph as described below in equation 2,

$${G}_{s} ⊂ G$$

As evidence for each skill, syllabi and lecture schedules of open courses are utilized, from which concepts are identified. These become positive seed concepts for each skill as described below in equation 3,

$${T}_{s} {}^{+ i ⊂ {V}_{i}}$$

It is to be noted that the curriculum concepts are not specific enough. In other words, the positive seeds are typically not the leaves of the skill graph to be constructed. To adapt the CRUMBTRAIL algorithm for this task at an initializer stage is executed before invoking CRUMBTRAIL as a pruner. The positive seeds contain both leaf concepts and intermediate concepts from the category hierarchy in G. The initializer augments the positive seeds with concepts from V that are at most k-hops away from the intermediate concepts in the category hierarchy in G. The augmented positive seed set along with G is provided as input to CRUMBTRAIL. This algorithm climbs bottom-up, traversing concepts from leaf concepts to the layer containing the intermediate concepts, searching paths that connect the intermediate concepts to the leaf concepts. It then unifies these paths to construct the skill graph Gₛ. However, Eₛ now contains only the category hierarchy relations. It postprocesses this by adding to Eₛ relations of other types from E between the concepts already in Vₛ. One of the important uses of the skill-graphs is the annotation of textual constructs associated with interviews, such as resumes, questions, reference answers and candidate answers with concepts from these. Referring now to the example the following sentence from a candidate answer: “The HMM state variables are unobserved.”. Annotation should identify the mentions ‘HMM’ and ‘state variables’, and tag these with the concepts Hidden Markov model. Annotation should also identify Machine Learning as the primary skill of the answer.

Further, a question bank constructor comprising technical long form questions related to the curriculum using a resource corpus. The questions are generated using a template-based approach to assess candidate’s expertise on (i) a concept understanding, (ii) the properties of the concept, and (iii) an ability to apply concept knowledge for the next question, wherein a difficulty level is assigned for each question. Further, a multi-span answer is extracted for each question from the resource corpus. The question bank Constructor generates questions for a skill, such as Machine Learning, given a reference document for the skill, such as the Wikipedia® page Hidden Markov model, and the skill graph.

The template-based approach for question generation provides better results. Here, different types of templates were designed that can test various aspects of candidate’s knowledge during an interview such as,
i. Basic understanding of technical concepts (‘definition-of’ type of templates What is X? or How do you define X? e.g., What is Hidden Markov Model?).
ii. Details about properties of a concept (‘attribute-of’ template: What are different types of X? e.g., What are different types of regularization techniques?).
iii. Ability to apply the knowledge (‘applications-of’ template: What are different applications of X? e.g., What are different applications of Markov Chains?).
iv. Procedural knowledge (‘How-do-you-V-X’-type of templates: How do you select hyper-parameters to minimize the generalization error?).
v. Ability to identify pros and cons (‘advantage-disadvantage’ templates: What are the advantages of Decision tree?).
vi. Ability to reason (‘Why’-type of templates: Why the set of all attributes is a trivial super key in RDBMS?) etc.

Further, Wikipedia® articles related to technical concepts in the syllabi of courses for a skill are used as the input text for the question generation process. The input text of each article is parsed, and the dependency relations are processed sentence-wise. For each question template, the phrases in each sentence that satisfy the linguistic constraints as well as admissible dependency relations to fill the slots (i.e., parameters of the template) are identified. Each question q ∈ Q has various attributes such as,
(a) Each question q has a primary skill s_{q} and one or many concepts c_{q} associated with the skill. Consider the question “What is hidden in an HMM?”. This has primary skill Machine Learning, and associated concept HMM.
(b) Secondly, each question follows a structural template that captures in long-form nature. The question above follows the ‘attribute-of’ template. Other templates are ‘definition-of’, ‘reason-for’, etc.
(c) Questions are of varying difficulty levels. This is important for discriminating between expertise levels of the candidate - a ‘difficult’ question is useful for separating high and medium levels of expertise, and a ‘simple’ question for ‘exposure’ and ‘medium’ levels of expertise. Let δ_{q} ∈ Δ denote the difficulty level of question q, where Δ is the ordinal set of difficulty levels.
(d) Finally, each question q has a set of reference answers as described below in equation 4,
$${A}_{q}^{∗} = \left\{{a}_{q 1}^{∗} , {a}_{q 2}^{∗} , …\right\}$$

Note that these are long-form answers, typically a few sentences long. The following is a reference answer for the HMM question above: “An HMM consists of a sequence of states variables, which follow a Markov process. Emission variables are generated conditioned on the states. The emission variables are observed, while the state variables are hidden.” Such answers reflect a deeper understanding of the domain compared to factoid answers. Each question may have multiple acceptable long-form reference answers. Let Dₛ denote the corpus of documents associated with skill s. Each document d ∈ Dₛ has a title T_{d} , primary skill S_{d} and a sequence W_{d} of sentences as described below in equation 5,

$${W}_{d} = \left\{{W}_{d 1} , {W}_{d 2} , … {W}_{d n}\right\}$$

For example, the Wikipedia® page titled ‘Hidden Markov model’ is useful reference document for HMM.

The answer extractor is used to extract reference answers [symbol] to a given technical question q, and its associated skill s and a given corpus of documents Dₛ for that skill. In one embodiment, the proposed system has two main modules: (1) Document retriever and (2) Document reader. The Document retriever reduces the search space for the reader module and retrieves only those article(s) that are likely to contain an answer to the given question. Therefore, a multi-stage retriever process is designed. The first stage uses a rule-based algorithm to identify Wikipedia® page titles which appear in the question string from a given corpus of documents Dₛ for a skill s. If no such document is found, an ensemble of BM25+ ranking algorithm and (DrQA) retriever is used to find top n relevant documents. The Document reader takes as input the n documents returned by the retriever module for a given question and processes them to identify the ranked list of relevant answer spans. For identifying answers from the retrieved documents, we built on top of a documents, the multitask model of the DrQA reader is further fine-tuned on manually created question-answer pairs from technical domains. While fine-tuning, some of the hyperparameters are updated. Further, the answer spans are post-processed by selecting the entire sentence(s) which contains the DrQA answer span to ensure that the extracted answer has complete sentences.

At step 304 of the method 300, the one or more hardware processors 104 is configured to rank a set of qualified candidates resume to be interviewed for the job description from a resume database, wherein each candidate resume includes atleast one concept associated with the skill graph. The resume information extractor analyzes resumes to extract education, skills, trainings, details of work experience and other relevant information about the candidate. For example, RINX extracts mentions of SKILL (e.g., Machine learning, Python), CONCEPT (e.g., Activation function, Maximum margin), ROLE (e.g., Developer), TASK (e.g., Performance Tuning), among other entity types. It uses unsupervised methods to assign a proficiency level (e.g., 1 to 5) to each SKILL mentioned in the resume. RINX also includes an algorithm for ranking resumes for a given job description using the extracted information. Further, a candidate profile is constructed for each candidate and an interviewer profile is constructed for each interviewer, wherein the candidate profile is constructed by extracting concepts and its expertise level from resume, wherein the interviewer profile is constructed from prior interviewer actions.

In one embodiment, to shortlist candidates given pool of resumes R and a JD j, is to identify a preliminary set of resumes from R relevant for the j are identified. There are many ways to assist the interviewer for this task. The first is to provide a ranking of the candidate resumes considering the skills and concepts and their desired expertise levels in the JD. This is done by computing a relevance score, score (j, r) ∈ [0, 1] for this job description and each resume r ∈ R. In addition, interviewers wish to explicitly search for candidates using specific criteria, (e.g., candidates who have executed a project in computer vision using deep learning), and also filter along specific dimensions (e.g., department = computer science, degree = masters). The IA bot provides all these modes of assistance for shortlisting candidates from a large pool. To each interviewer, it recommends each interviewer one or more candidate resumes selected by similar interviewers, and one or more candidate resumes like those selected by similar interviewers. The example candidate is included in the short-list. Now, the goal of an interview is to assess the true expertise of the candidate on the relevant skills and concepts, as accurately and confidently as possible. This is achieved by asking the candidate a short sequence of technical questions that test the candidate’s understanding of relevant concepts for the skill.

At step 306 of the method 300, the one or more hardware processors 104 is configured to recommend each interviewer prior initiating the interview using a pre-interview question recommender, a set of question and reference answer pairs from the question bank relevant to each candidate profile. The pre-interview question recommender selects a sub-set of questions from the question bank ahead of the interview, which an interviewer uses to prepare by noting possible questions to ask. This involves selecting questions [symbol] ⊂ Q. Considering the skills and expertise levels in the resume r and JD j. For the given example, this may include some ‘high’ difficulty questions on HMM, ‘medium’ and ‘high’ difficulty questions on Machine Learning, ‘low’ difficulty questions on Deep Learning. This forms an initial plan in which the interviewer may modify by considering new concepts and questions. The pre-interview question recommender performs the steps initially to determine, a weight for each concept in the skill graph based on the total number of questions associated with the concept in the question bank, Further, the interviewer recommends the set of technical questions by (i) sampling concepts according to their weights with its difficulty level, and (iii) choosing technical questions for selective concepts and difficulty levels. Each concept weights are updated based on interviewer’s feedback and collaborative filtering. The pre-interview question recommender selects a relevant subset of nq question from the question bank, given extracted skills Sᵣ and concepts Vᵣ from a resume and the skills Sⱼ and concepts Vⱼ in the JD, and annotations of question bank questions. The selected questions should have good coverage of the skill graph concepts given the seeds Vⱼ and Vᵣ, and an appropriate mix of difficulty levels. In one embodiment an unsupervised sampling-based variation is used, where the weight of each concept is determined by the number of questions associated with the question bank, and the concepts are selected by sampling according to the weights. The additional level of sampling is done to select the difficulty level. The distribution over difficulty levels is adjusted according to prior assessments Y^{r}(v).

Referring now to the step 308 of the method 300, the one or more hardware processors 104 is configured to recommend each interviewer by the IA bot at every interview step using an in-interview question recommender, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question. The in-interview question recommender recommends each interviewer based on dynamic understanding of the interview context by updating (i) a coverage of skills for previously asked question, (ii) the weight of concepts in previously asked question, (iii) assessment of skills and concepts based on previously asked question, and (iv) difficulty level of the question and candidate’s response. The in-interview question recommender is the next stage to pre-interview question recommender in the actual interview. In this stage, the interviewer asks a sequence of questions to the candidate, with the goal of assessing the candidate’s expertise at the level of skills as well as concepts, based on the candidate’s answers to these questions. The goal of in-interview assistance is to provide dynamic recommendations to the expert, both for asking questions and for assessment. The interviewer provides feedback for these recommendations, and the recommendations are updated based on these. The interview state for a candidate resumes r and a job description j at any step t during the interview is represented using the interview history [symbol] , the interview plan [symbol] , and the assessment [symbol] . The interview history H^{(t)} is a sequence of history elements {h^{(t)}, h^{(t-1)}, ...} where, h^{(t')} is represented below in equation 6,

$${h}^{\left({t}^{′}\right)} = \left({q}^{\left({t}^{′}\right)} , {a}^{\left({t}^{′}\right)}\right)$$

consists of the question statement q^{(t')} asked by the interviewer at step t′ and the corresponding answer statement a^{(t')} from the candidate.

In one embodiment, the assessment Y^{(t)}consists of the assessments Y^{(t)} (s)for individual skills s, Y^{(t)} (v) for individual concepts v, and Y^{(t)} (a^{(t')}) for all candidate answers so far (t′ ≤ t). All assessments belong to an ordinal scale (0, ..., L). This is the first form of in-interview assistance provided by the IA bot to the interviewer. As shown in Table 1, the IA bot assesses the candidate for individual questions, as well as for Machine Learning (ML), Deep Learning (DL) and HMM over 5 steps. As can be seen, as the interview progresses, starting from an initial assessment based on the resume alone, the assessments for skills and concepts evolves and slowly converges, based on the assessments of individual questions associated with those skills and concepts. The second form of assistance at any step t is the dynamic interview plan π^{(t)} for conducting the rest of the interview, and the completion estimate k^{(t)}. Specifically, the plan π^{(t)} consists of the skill s(π^{(t)})for the next question, the difficulty level δ(π^{(t)}) of the question, and a list of questions Q(π^{(t)}) for that specific skill and difficulty level. The Assistant recommends the plan at the beginning of each step. As shown in Table 1, the plan at t = 1 has an easy question on Bayes Net. Note that for brevity have shown only one question in each plan. The plan evolves with the assessments - the difficulty level rises when the candidate’s answer is assessed to be good and the assessment of the skill or concept increases. The overall completion estimate of the interview at step t is given by k^{(t)}∈ [0, 1]. This is further decomposed into completion estimate k^{(t)} (s) for individual skills s and k^{(t)} (v) for concepts. Initially, the completion estimate is lower for more important skills, since these require deeper assessment. For each skill and concept, the completion estimate increases as more questions are asked. The interviewer can provide feedback to the Assistant at any step. This can be feedback F_{π}(π^{(t)}) about the plan, or feedback F_{y}(Y^{(t)}) about the assessment as shown in Table 1. In assessment feedback, the interviewer may override the Assistant’s assessment for an individual answer, or for a concept or skill.

The in-interview question recommender, at each step of the interview, given an assessment Y(a^{(t-1)})of the latest answer, has two parts: (a) update the question plan π^{(t)} which includes the skill, concept, difficulty level for the next question and specific questions, and (b) update the assessments of the skills Y^{(t)} (s)and concepts Y^{(t)} (v), and also the completions k^{(t)} (s) and k^{(t)} (v). Let n^{(t)} (v) indicate the number of questions asked so far on concept v, and N (v) the target number of questions as represented in equation 7,

$${\text{k}}^{\left(t\right)} \left(v\right) = {\text{n}}^{\left(t\right)} \left(v\right) / N \left(v\right)$$

The question numbers and completion for skills are determined by aggregating over concepts in each skill. Let N indicate the target number of questions overall and N^{(t)} the number of questions asked so far. Then the probability P^{(t)} (v)of choosing a concept for the next question is N(v) - n^{(t)} (v)/N^{(t)} The update at each step, considers the last question’s skill s, concept v, difficulty δ, and answer assessment Y (a) and the current assessments Y (s) and Y (v).

TABLE 1

```
In-interview question recommender
t=1
A: Y(ML) = 3/5, Y(HMM) =4/5, Y(DL) =1/5, k(ML) =0.1, k(DL) =0.2
        Π: (BayesNet, Easy, What is a Bayesian Network?)
I: F_{π} = more specific
        t=2
A:π: (HMM, Easy, What is hidden in an HMM?)
I: “What is hidden in an HMM?”
C: “The HMM states are unobserved. So, these are called hidden.”
        t=3
A: Y(a) =4/5, Y(ML) =3.5/5, k(ML) =0.2
        π: (HMM, Med., What problem does the Viterbi algo solve?)
I: F_{y}(a) = 5/5
        t=5
I: F_{y}(ML) = 4.5/5
        t=5
A: k(ML)=0.8, k(DL) =0.2
        π: (DL, Easy, What are the advantages of word embeddings?)
```

The assessment update uses the posterior distribution for the assessment: P (Y (s) |δ, Y (a)) ∝ P (Y (s))P (Y (a) |Y (s), δ). Here P (Y (s)) captures the uncertainty in the current assessment. P(Y (a) |Y (s), δ) is the probability of an answer assessment given a difficulty level of the question and the candidate’s expertise on that skill, shared across all candidates. All these variables are ordinal, so that these are a set of categorical distributions. These can be learnt from past interviews. The completion updates for k(v) are straight-forward after incrementing n(v). The plan recommendation at each step consists of three-step sampling. First, the concept and skill are sampled from a distribution P (s, v | k(v), k(s)) based on the current completion of the skills and concepts. Next, the difficulty level is sampled from a distribution P (δ | v, Y (v)) based on the selected concept and the current assessment of it. This distribution captures suitability of a difficulty level given an assessment. For example, low difficulty levels are less suitable than high difficulty level when a candidate has high assessment. Finally, the question is sampled from a uniform distribution over previously unused questions for the selected concept and difficulty level. It is to be noted that the recommendation step is identical to the pre-interview recommendation strategy, with the prior estimates Y^{r}(v) replaced with the in-interview estimates Y^{t}(v) and the introduction of the completion k^{r}(v)which are 0 for pre-interview recommendation.

Referring now to the step 310 of the method 300, the one or more hardware processors 104 determine, an assessment score for the candidate provided answer using the reference answer extracted from the resource corpus and recommending next question to the candidate in response to the previous answer. In one embodiment, the answer assessor generates the assessment Y^{(t)} (a^{(t)}) for an answer statement a^{(t)} from the candidate for the question q^{(t)} during each step t of an interview, using the knowledge of the question q^{(t)} and its reference answer a*. This is a regression model with the most important features being the word level alignment and coverage of the candidate answer a^{(t)} with the reference answer a*. Using a paraphrase database, the alignment score considers the fraction of words in the two answers that are aligned with a semantically similar word in the other answer. The coverage is the fraction of reference answer words also present in the candidate answer. We extend this model with an additional feature, which is the concept-level alignment of the two answers using the skill-graph Gₛ of the primary skill s for the question. The candidate and reference answers are annotated using the skill graph to get the candidate concepts Vₐ and the reference concepts V_{a*}. These are then aligned using pair-wise concept similarities, which are calculated as ⅟s (V_{a*}, Vₐ), where s (V_{a*}, Vₐ) is the length of the shortest path in Gₛ between V_{a*} and Vₐ. The concept alignment score is the mean of the concept similarity scores of aligned pairs.

FIG. 4 illustrates an example scenario associated with initiating an interview session between interviewers and candidate including interview assistant using the system of FIG. 1, according to some embodiments of the present disclosure. The IA bot has an interface for an interviewer and another for the candidate. Interviewer Interface: The web-based interface for an interviewer has 3 different tabs for short-listing, pre-interview preparation and in-interview assistance. Administrators have a fourth tab for uploading resumes. Candidate Interface: The candidate interface is speech-based and invisible to the candidate. The candidate’s speech is captured using the interviewer’s device and transcribed automatically. The interviewer has the ability to make modifications to the candidate’s transcribed answer, which is passed to answer assessment, or he/she can directly modify the automated answer assessment.

In another embodiment, a summary of each candidate interview is generated using the transcript of the interview based on (i) total number of questions asked by the interviewer, (ii) the coverage of relevant skills and a combined summary of multiple interviews, (i) distribution of number of questions asked, (ii) distribution of number of skills covered, and (iii) distribution of number of questions asked. The Assistant performs summarization at two different levels,
(i) First, using the interview history, it creates detailed transcripts for individual interviews, containing individual question, candidate answers and assessments, along with their associated skills and concepts. Along with this, using the assessments and completion estimate at the end of the interview, it creates a summary of the interview containing the overall assessment, as well as skill-wise summaries, mentioning the number of questions asked, concepts covered and the skill-level assessment.
(ii) Secondly, the Assistant creates an overall summary for a collection of interviews, consisting of insightful statistics across interviews, by using their histories, assessments and completion estimates. The following are some examples distributions, for which means, and variances are reported: (a) number of questions asked per interview, (b) total number of skills assessed per interview, (c) number of resume skills assessed per interview, (c) number of times a question is repeated across interviews. Together, these indicate whether the interviews are rigorous and fair, while also enabling easy identification of outliers.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of automated interview assistance. The embodiments, thus provide method and system for providing assistance to interviewers. Moreover, the embodiments herein are a robust method collaborating the IA bot, interviewers and the candidate which can significantly reduce the workload of interviewers for conducting technical interviews. The IA bot starts with a pool of candidates resume and spans entire interview process. The present disclosure aids with (a) shortlisting candidates, (b) pre-interview question recommendations, (c) in-interview actions, such as in-interview question recommendation and answer and skill-level assessments, and (d) post-interview summarization. It receives multiple forms of feedback from the interviewer and updates its recommendations. Analysis of shortlisting quality showed the need of learning from past interviewer shortlists. Learning from past interviewing action needs to be addressed more broadly, while avoiding significant deviation from organizational standards and best practices. However, benefits are potentially much higher if less experienced interviewers can use the present system for conducting interviews without affecting quality. Evaluation with such interviewers is an important next step. It is envisaged that, beyond hiring, the system also aids in efficient allocation of newly hired employees by providing a searchable record of the hiring process to potential team leads seeking the right talent for their projects.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for providing assistance to interviewers, the method comprising:
initiating, via one or more hardware processors, an interview session associated with interviewing a plurality of candidates for a job description conducted by one or more interviewers executed by an interview assistant bot by performing the steps of:
(i) identifying, a skill graph from an open domain knowledge graph by mapping curriculum with each skill required for the job description, wherein the skill graph annotates textual constructs associated with the interview session, wherein the curriculum comprises one or more concepts,
(ii) constructing, a candidate profile of each candidate and an interviewer profile of each interviewer, wherein the candidate profile is constructed by extracting concepts and its expertise level from resume, wherein the interviewer profile is constructed from prior interviewer actions, and
(iii) generating using a resource corpus, a question bank comprising technical long form questions related to the curriculum;
selecting, via the one or more hardware processors, a set of qualified candidates resume to be interviewed for the job description from a resume database, wherein each candidate resume includes atleast one concept associated with the skill graph;
recommending, each interviewer by the interview assistant bot prior initiating the interview using a pre-interview question recommender executed via the one or more hardware processors, a set of question and reference answer pairs from the question bank relevant to each candidate profile;
recommending, each interviewer by the interview assistant bot at every interview step using an in-interview question recommender executed via the one or more hardware processors, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question; and
determining, via the one or more hardware processors, an assessment score for the candidate provided answer using the reference answer extracted from the resource corpus and recommending next question to the candidate in response to the previous answer.

2. The processor implemented method as claimed in claim 1, wherein the interview assistant bot recommends each interviewer with one or more candidate resumes selected by similar interviewers, and one or more candidate resumes similar to those selected by similar interviewers.

3. The processor implemented method as claimed in claim 1, wherein the question bank generation comprises:
generate technical long form questions for the question bank using a template approach to assess candidate’s expertise on (i) a concept understanding, (ii) the properties of the concept, and (iii) an ability to apply concept knowledge for the next question given the interviewer, wherein a difficulty level is assigned for each question; and
extracting, a multi-span answer for each question from the resource corpus.

4. The processor implemented method as claimed in claim 1, wherein the pre-interview question recommender comprises:
determining, a weight for each concept in the skill graph based on the total number of questions associated with the concept in the question bank;
recommending the interviewer, the set of technical questions by (i) sampling concepts according to their weights with its difficulty level, and (iii) choosing technical questions for selective concepts and difficulty levels; and
updating, each concept weights based on interviewer’s feedback and collaborative filtering.

5. The processor implemented method as claimed in claim 1, wherein the in-interview question recommender recommends each interviewer based on dynamic understanding of the interview context by updating (i) a coverage of skills for previously asked question, (ii) the weight of concepts in previously asked question, (iii) assessment of skills and concepts based on previously asked question, and (iv) difficulty level of the question and candidate’s response.

6. The processor implemented method as claimed in claim 1, wherein the assessment score for each candidate’s answer is assessed using a regression method has as feature concept-alignment in the skill graph, and surface form similarity between the candidate’s answer and the reference answer.

7. The processor implemented method as claimed in claim 1, wherein interviewer profile is updated based on (i) the skills and expertise levels in the candidate profiles shortlisted by the interviewer, (ii) the skills and the difficulty of questions queried, and (iii) the utilization of recommendation provided by the interview assistant bot.

8. The processor implemented method as claimed in claim 1, further comprises:
generating, a summary of each candidate interview using the transcript of the interview based on (i) total number of questions asked by the interviewer, (ii) the coverage of relevant skills and a combined summary of multiple interviews, (i) distribution of number of questions asked, (ii) distribution of number of skills covered, and (iii) distribution of number of questions asked.

9. A system for providing assistance to interviewers comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
initiate, an interview session associated with interviewing a plurality of candidates for a job description conducted by one or more interviewers executed by an interview assistant bot by performing the steps of:
identifying, a skill graph from an open domain knowledge graph by mapping curriculum with each skill required for the job description, wherein the skill graph annotates textual constructs associated with the interview session, wherein the curriculum comprises one or more concepts,
constructing, a candidate profile of each candidate and an interviewer profile of each interviewer, wherein the candidate profile is constructed by extracting concepts and its expertise level from resume, wherein the interviewer profile is constructed from prior interviewer actions, and
generating using a resource corpus, a question bank comprising technical long form questions related to the curriculum;
select, a set of qualified candidates resume to be interviewed for the job description from a resume database, wherein each candidate resume includes atleast one concept associated with the skill graph;
recommend, each interviewer by the interview assistant bot prior initiating the interview using a pre-interview question recommender, a set of question and reference answer pairs from the question bank relevant to each candidate profile;
recommend each interviewer by the interview assistant bot at every interview step using an in-interview question recommender, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question; and
determine, an assessment score for the candidate provided answer using the reference answer extracted from the resource corpus and recommending next question to the candidate in response to the previous answer.

10. The system as claimed in claim 9, wherein the interview assistant bot recommends each interviewer with one or more candidate resumes selected by similar interviewers, and one or more candidate resumes similar to those selected by similar interviewers.

11. The system as claimed in claim 9, wherein the question bank generation comprises:
generate technical long form questions for the question bank using a template approach to assess candidate’s expertise on (i) a concept understanding, (ii) the properties of the concept, and (iii) an ability to apply concept knowledge for the next question given the interviewer, wherein a difficulty level is assigned for each question; and
extracting, a multi-span answer for each question from the resource corpus.

12. The system as claimed in claim 9, wherein the pre-interview question recommender comprises:
determining, a weight for each concept in the skill graph based on the total number of questions associated with the concept in the question bank;
recommending the interviewer, the set of technical questions by (i) sampling concepts according to their weights with its difficulty level, and (iii) choosing technical questions for selective concepts and difficulty levels; and
updating, each concept weights based on interviewer’s feedback and collaborative filtering.

13. The system as claimed in claim 9, wherein the in-interview question recommender recommends each interviewer based on dynamic understanding of the interview context by updating (i) a coverage of skills for previously asked question, (ii) the weight of concepts in previously asked question, (iii) assessment of skills and concepts based on previously asked question, and (iv) difficulty level of the question and candidate’s response.

14. The system as claimed in claim 9, wherein the assessment score for each candidate’s answer is assessed using a regression method has as feature concept alignment in the skill graph, and surface form similarity between the candidate’s answer and the reference answer.

15. The system as claimed in claim 9, wherein interviewer profile is updated based on (i) the skills and expertise levels in the candidate profiles shortlisted by the interviewer, (ii) the skills and the difficulty of questions queried, and (iii) the utilization of recommendation provided by the interview assistant bot.

16. The system as claimed in claim 9, further comprises:
generating, a summary of each candidate interview using the transcript of the interview based on (i) total number of questions asked by the interviewer, (ii) the coverage of relevant skills and a combined summary of multiple interviews, (i) distribution of number of questions asked, (ii) distribution of number of skills covered, and (iii) distribution of number of questions asked.

17. One or more non-transitory machine-readable information storage mediums comprising one or more instructions which when executed by one or more hardware processors perform actions comprising:
initiating, an interview session associated with interviewing a plurality of candidates for a job description conducted by one or more interviewers executed by an interview assistant bot by performing the steps of:
identifying, a skill graph from an open domain knowledge graph by mapping curriculum with each skill required for the job description, wherein the skill graph annotates textual constructs associated with the interview session, wherein the curriculum comprises one or more concepts,
constructing, a candidate profile of each candidate and an interviewer profile of each interviewer, wherein the candidate profile is constructed by extracting concepts and its expertise level from resume, wherein the interviewer profile is constructed from prior interviewer actions, and
generating using a resource corpus, a question bank comprising technical long form questions related to the curriculum;
selecting, a set of qualified candidates resume to be interviewed for the job description from a resume database, wherein each candidate resume includes atleast one concept associated with the skill graph;
recommending, each interviewer by the interview assistant bot prior initiating the interview using a pre-interview question recommender, a set of question and reference answer pairs from the question bank relevant to each candidate profile;
recommending each interviewer by the interview assistant bot at every interview step using an in-interview question recommender, the set of question and reference answer pairs from the question bank relevant to each candidate profile and their interview history, wherein each question provided by the interviewer to the candidate is based on atleast one of (i) the interview assistant bot recommended question answer pairs, and (ii) the interviewer’s formulated question; and
determining, an assessment score for the candidate provided answer using the reference answer extracted from the resource corpus and recommending next question to the candidate in response to the previous answer.

18. The one or more non-transitory machine-readable information storage mediums of claim 17, wherein the question bank generation comprises:
generate technical long form questions for the question bank using a template approach to assess candidate’s expertise on (i) a concept understanding, (ii) the properties of the concept, and (iii) an ability to apply concept knowledge for the next question given the interviewer, wherein a difficulty level is assigned for each question; and
extracting, a multi-span answer for each question from the resource corpus.

19. The one or more non-transitory machine-readable information storage mediums of claim 17, wherein the pre-interview question recommender comprises:
determining, a weight for each concept in the skill graph based on the total number of questions associated with the concept in the question bank;
recommending the interviewer, the set of technical questions by (i) sampling concepts according to their weights with its difficulty level, and (iii) choosing technical questions for selective concepts and difficulty levels; and
updating, each concept weights based on interviewer’s feedback and collaborative filtering.

20. The one or more non-transitory machine-readable information storage mediums of claim 17, wherein the in-interview question recommender recommends each interviewer based on dynamic understanding of the interview context by updating (i) a coverage of skills for previously asked question, (ii) the weight of concepts in previously asked question, (iii) assessment of skills and concepts based on previously asked question, and (iv) difficulty level of the question and candidate’s response.
